(19) United States
(12) Patent Application Publication
(10) Pub. No.: US 2008/0301122 A1
(43) Pub. Date: Dec. 4, 2008

(54) Searching techniques

(75) Inventors: Frederic Almeida, Le Plan de Grasse (FR); Claudio Lavecchia, Biot (FR); Clovis Schaff, Mougins (FR)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Amadeus S.A.S., Sophia Antipolis Cedex (FR)

(21) Appl. No.: 11/809,028

(22) Filed: May 31, 2007

(51) Int. Cl. G06F 17/30

(52) U.S. Cl. 707/5; 707/E17.017

(57) ABSTRACT

A method of online searching for a service or product, the method comprising: obtaining a first search request from a user, the first search request including a set of search criteria; storing the set of search criteria at a predetermined location; searching for a service or product which matches the set of search criteria; generating a first set of recommendations of a service or product which matches the set of search criteria for communication to the user; storing the first set of recommendations; generating a second request to change the range of one or more of the set of search criteria of the first search request in a predetermined manner; retrieving the set of search criteria from the predetermined location to form the basis of the search criteria for the second request; changing the or each search criteria of the set of search criteria in said predetermined manner to form an changed set of search criteria; searching for a service or product which matches the changed set of search criteria; generating a second set of recommendations of the service or product which matches the changed search criteria for communication to the user; concatenating the first set of recommendations with the second set of recommendations to form a concatenated set of recommendations having a predetermined result profile.

### FIELD OF THE INVENTION

The present invention relates to a method and apparatus for providing improvements in or relating to searching techniques, particularly but not exclusively in the domain of Internet searching.

### BACKGROUND OF THE INVENTION

Since the arrival of e-commerce users have been buying products and services over the Internet. The products and services that are purchased in this way are limitless. One particular environment where online purchasing and searching are particularly popular is in the purchase of tickets, for example, for flights, theatres, etc. or for any other type of travel related service.

In the environment of booking flights many of the online reservation services are based on an architecture that encompasses three main components. These are the Internet browser, the booking engine and a back-end system of some sort or another. The Internet browser is a tool that allows the online user to look for a specific flight or other reservation. The booking engine is a middle-tier component that applies business logic to the user request before it is sent to the back-end and to the back-end response before it is returned to the user. The back-end system is typically a global distribution system (GDS) or a CRS.

Typically, an online user interfaces with the Internet browser and generates a flow of pages. The flow of pages includes an early step to check the availability of flights for the user defined by the date and destination of the trip. The page where this happens is generally referred to as the search page. Once the online user has completed the search page the data is sent to the back-end by the booking engine. The back-end may then query one or more modules within its database to determine the list of available flights that fit the search criteria. In response to the search by the online user many availability modules are designed to return flight solutions that consists of a mix of available fares and dates. For example the N cheapest flight solutions for a specific date are displayed to the user, these may include multiple routes and single routes, etc. In addition, it is now common for availability to be displayed around the date specified by the user, for example a maximum of i days around both the outbound and inbound flights.

US2005/0273373 (Sabre Inc.) discloses a method and system for the determination of low-priced flights for a specific date or for a range of dates. The method includes a “pruning” process in order to remove results that do not match the user's request. This is achieved by means of an algorithm in order to determine the kinds of flight combination that have the lowest price. The system then displays all the combinations in a grid or matrix to the user which may include a fare template.

US 2005/086087 (inventors: Razza et al) discloses a method and system which prevents the user from making multiple requests to find the required flight and price combination for a specific date or range of dates. The system includes a flexible date radio button which can launch a wide request and an interface page to specify optional search criteria.

US 2002/065688 (British Airways) discloses a method and system which prevents a user from making multiple requests to make a reservation. The system can process multiple queries at the browser level instead of sending every query to the web server or stop after the first query has been made. Datasets of the reservation database are downloaded to the terminal of the user. This can then be used by the user to modify his request and obtain replies in a short timescale.

Whilst these proposals deal with some of the issues associated with online searching for reservations meeting certain criteria they do not solve all the problems.

### SUMMARY OF THE INVENTION

One object of the present invention is to provide a method and system which overcomes at least some of the problems associated with the prior art and offers a truly flexible online reservation searching capability.

In addition, a further object is to provide this in an intuitive and user-friendly manner and present the information obtained by the search in a manner that will assist and facilitate decision-making by the user.

A still further object is to give a means of changing the search results profile based on user or other requirements.

A method of online searching for a service or product, the method comprising:

obtaining a search request from a user, the search request including a set of search criteria;

storing the set of search criteria at a predetermined location;

searching for a service or product which matches the set of search criteria;

generating a first set of recommendations of a service or product which matches the set of search criteria for communication to the user;

storing the first set of recommendations;

generating a second request to change the range of one or more of the set of search criteria of the first search request in a predetermined manner;

retrieving the set of search criteria from the predetermined location to form the basis of the search criteria for the second request;

changing the or each search criteria of the set of search criteria in said predetermined manner to form an changed set of search criteria;

searching for a service or product which matches the changed set of search criteria;

generating a second set of recommendations of the service or product which matches the changed search criteria for communication to the user:
concatenating the first set of recommendations with the second set of recommendations to form a concatenated set of recommendations having a predetermined result profile, such that the concatenation occurs so as to ensure that no duplicates occur in the concatenated set of recommendations.

This invention has a number of advantages. The invention supports multiple requests and aggregates the result in a single output. The requests can be presented as a result of the non-flexible request by performing successive flexible requests. These are referred to here in as a deep request and a wide request respectively. Similarly the invention allows the results of a flexible request to be performed by successive nonflexible requests by extending the date range. There are several requests from the booking engine to the GDS or equivalent that are transparent to the user. The results in either case are presented in the intuitive and transparent fashion with no requirement for the user to enter any additional data than that entered in the first instance. The benefits of aggregating the results in this way means that the booking engine does not send further requests to the GDS which results in some economy in navigation delays. In addition the user can browse the event results without experiencing any navigation delays. The aggregated results of the flexible and nonflexible request contain information that is far more relevant to the online user than the non-aggregated results of two separate requests. The method and system of the invention are such that the precision of the aggregated results is optimized.

### BRIEF DESCRIPTION OF THE DRAWINGS

Reference will now be made by way of example to accompanying drawings in which:

FIG. 1 is a diagram showing the different types of request, in accordance with one aspect of the present invention.

FIG. 2 is a screenshot of a nonflexible request for a return trip in accordance with one aspect of the present invention.

FIG. 3 is a screenshot showing the means by which a deep request can be extended with a wide request in accordance with one aspect of the present invention.

FIG. 4 is a diagram showing the communications that occur when a simple request is sent from the browser to the GDS, in accordance with one aspect of the present invention.

FIG. 5 is an example of an API request, according to one aspect of the present invention.

FIG. 6 is an example of a reply to the API request of FIG. 5, in accordance with one aspect of the present invention.

FIG. 7 is a diagram showing the communications that occur when a simple request is extended between the browser and the GDS, in accordance with one aspect of the present invention.

FIG. 8 is a diagram showing a results profile for an expanded period search, in accordance with one aspect of the present invention.

### DETAILED DESCRIPTION OF THE INVENTION

For the sake of simplicity a range of number of days around a central date of +/−1 day has been selected as an example to aid the description of the invention. In other words the range of three days is presented as the example. It will be appreciated however that ranges of five days (plus/minus two days), seven days (plus/minus three days) or any other range of dates may also be used. From a business and technological standpoint the range of dates used may be optimized for different applications.

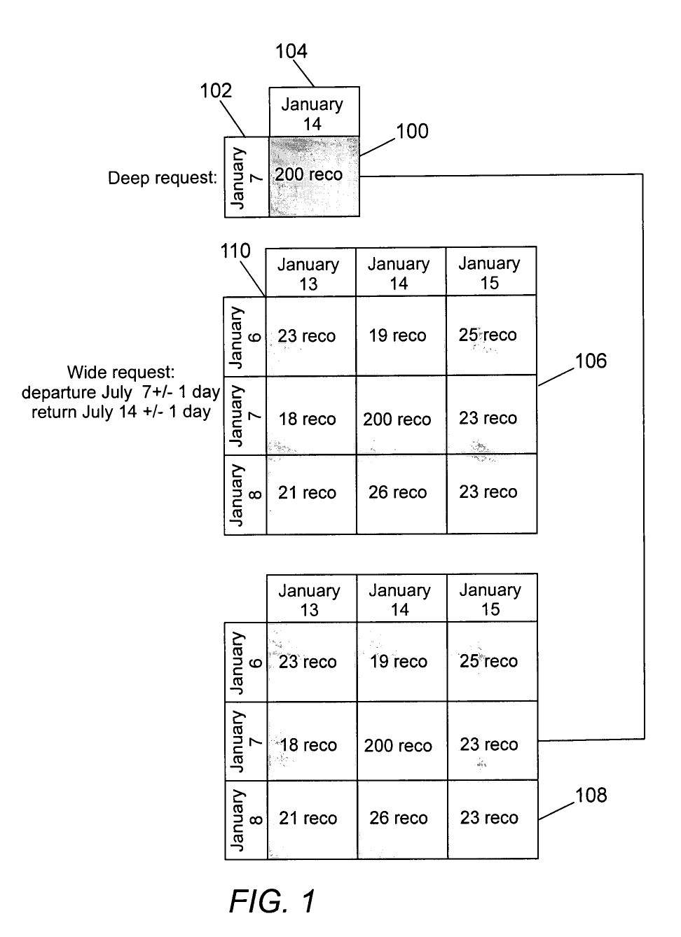

Referring to FIG. 1 an embodiment of the invention will now be described. A user makes a request to see the cheapest flights for a given itinerary on a nonflexible date (also referred to as a “deep request”) 100. The request relates to the departure date of January 7^{th} 102 and return date of January 14^{th} 104. The result of this request is a response with, for example, 200 recommendations (for example the cheapest 200 recommendations that match with the search criteria). If after inspecting the results the user decides that it would be interesting to determine if there are any cheaper or more convenient flights in surrounding dates the present invention allows this to occur without the necessity to re-enter the original search criteria. The flights available for three days both in terms of departure and return are shown in table 106. However the user does not want to lose the first set of data 100 and the present invention allows for the two results to be presented together in table 108. The manner in which this occurs will be described in greater detail below. The request covering three days shown in table 106 is herein referred to as the “wide request” and includes departure dates January 6, 7 and 8; and return dates January 13, 14 and 15. Each combination of dates for departure and return shows the number of recommendations for example 110 for a departure of January 6^{th} and return on the 13^{th}.

There are in fact two ways in which the so-called deep request can be converted into a wide request in order to give a different result profile to the final results presented to the user. These two ways are referred to as a concurrent request and a sequential request.

A concurrent request retrieves all the results in a single request. In other words the concurrent request takes the input from the user and requests a set of results for the selected dates for each journey and at the same time requires further sets of results in relation to an expanded period. This results of a reply including the 200 best flights for the user specified date and a lower number of results for the expanded period. The actual number of results for the expanded period can be selected in accordance with a required result profile to be presented to the user. This will be described in greater detail below. The result in relation to both the user specified date and the expanded period can be stored in a cache. The presentation of results to the user may be in respect of the specific date or the expanded period depending on the requirements of the user or other settings associated with the search. Further details relating to the concurrent request process will be presented below.

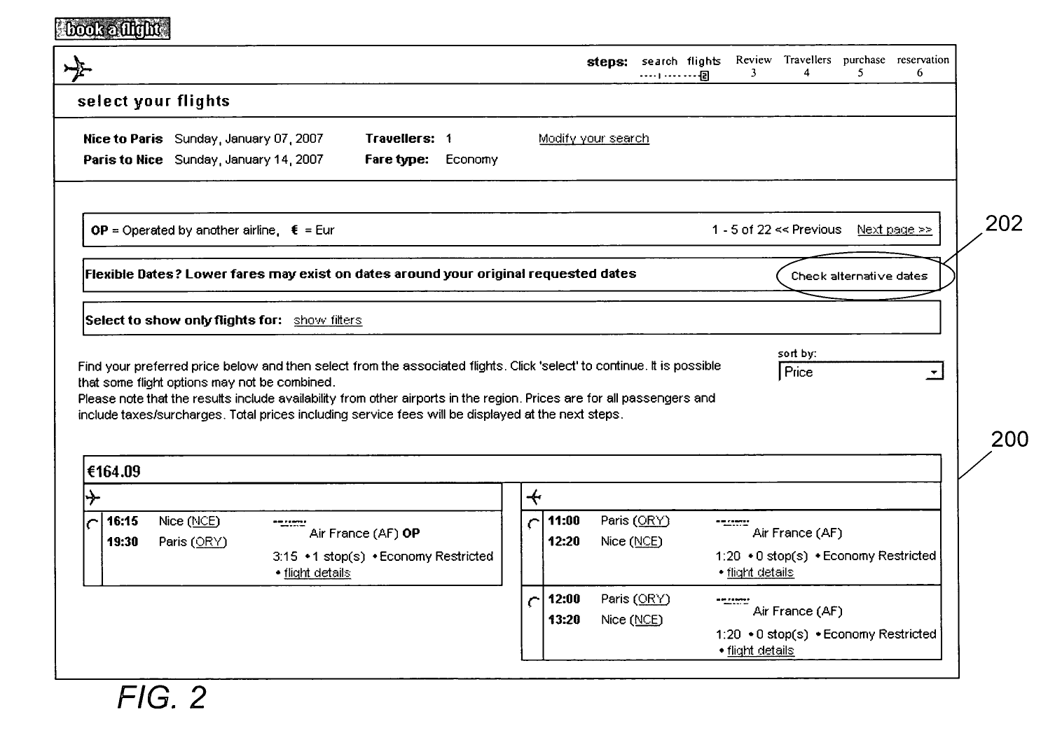

A sequential request on the other hand requests a set of results of the selected dates for each part of the journey and provides as is shown in FIG. 2 the ability to expand the period and create a flexible request by means of a “check alternative date” radio button 202.

The screenshot in FIG. 2 shows all the expected information such as departure location, destination location, number of travelers, date, fare type etc. The screenshot shows a few available flight options 200, but in reality the number of flights solutions available is considerably bigger, typically up to about 200 recommendations. The manner in which the user can see more of the recommendations, can be by any appropriate means, as will be appreciated by the skilled person. The screenshot also shows a “check alternative dates” radio button 202. It is this button 202 which can be used by the online user to change the search from a deep request to a wide request, or vice versa.

If the online user clicks on the “check alternative dates” button the invention performs a second requests using the same search criteria as the original search without the need for the online user to re-enter the data. The result is to look for flexibility around the outbound and inbound dates that could be plus or minus one or more days, in other words to extend the search. The time range may be specified by the online user or may be a standard-setting programmed into the booking engine, Internet browser or whatever.

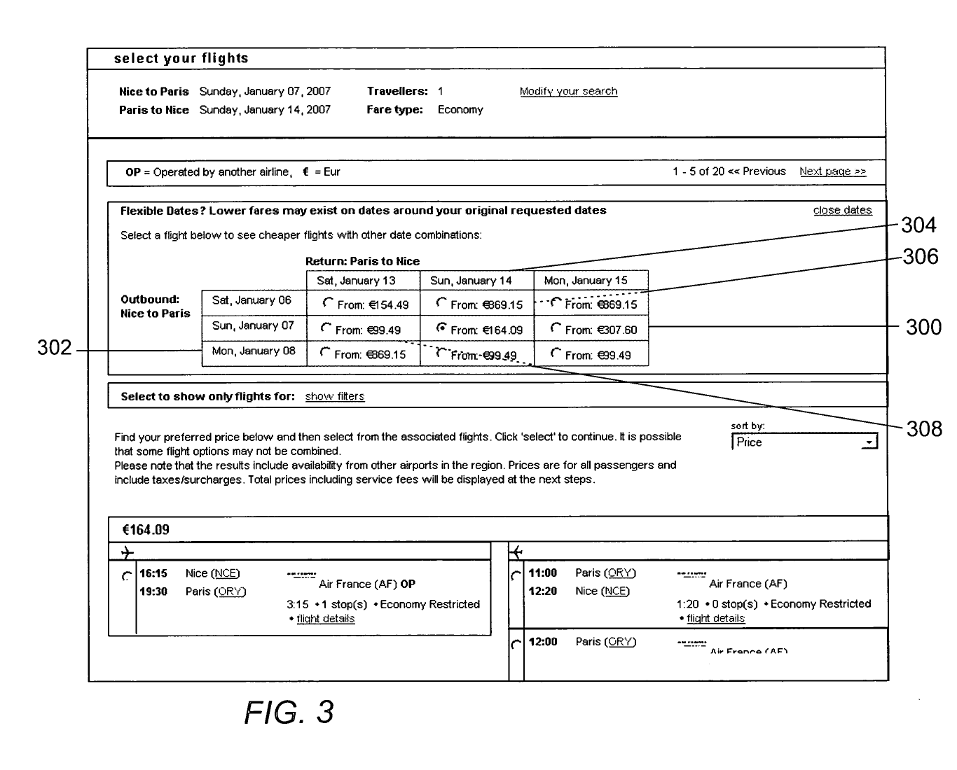

When the search is extended from a deep request i.e. a nonflexible request to a wide request i.e. the flexible request in terms of time, date or whatever carried out in a sequential request manner. The resultant screenshot will be in the form shown for example in FIG. 3. The 3×3 matrix 300 includes outbound date details 302 and return date details 304. The 3×3 matrix includes a set of recommendations corresponding to a combination of outbound and return date. For each set of recommendations for a given combination of dates there is an indication of a “from: Price”. From this it can be seen that the selected combination of dates box 306 in the matrix provides more expensive recommendations than in other possible combinations of date. For example, box 308 corresponds to the same outbound date for the journey but a day earlier for the return journey. By checking one of the radio buttons in the matrix a detailed list of available flight appears immediately. The flights solutions are cached and no information is exchanged with the backend at this point in the process. The precision of the first request is preserved meaning that the 200 or more recommendations for the original outbound and return journeys (ie January 7 to January 14) may be accessed by clicking the radio button on box 306. In other words there are about 200 recommendations for box 306 and about 25 recommendations for each of the boxes surrounding box 306.

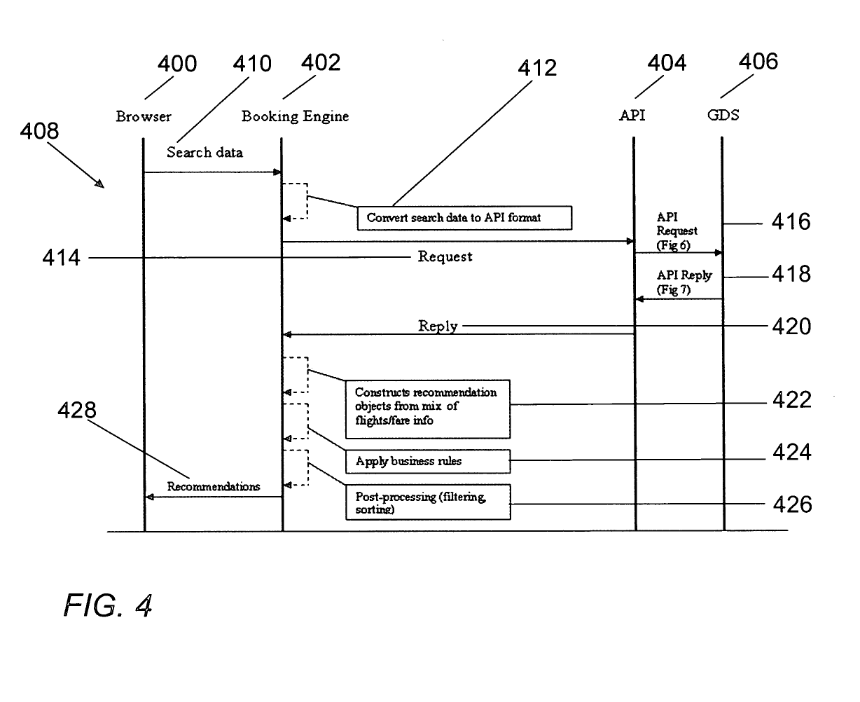

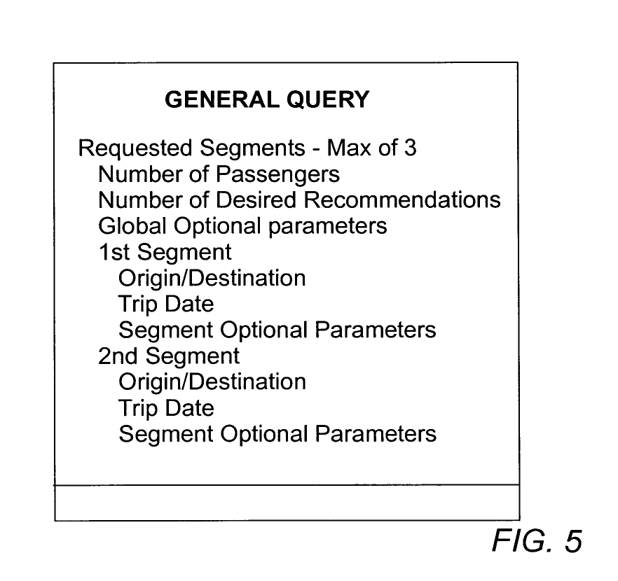

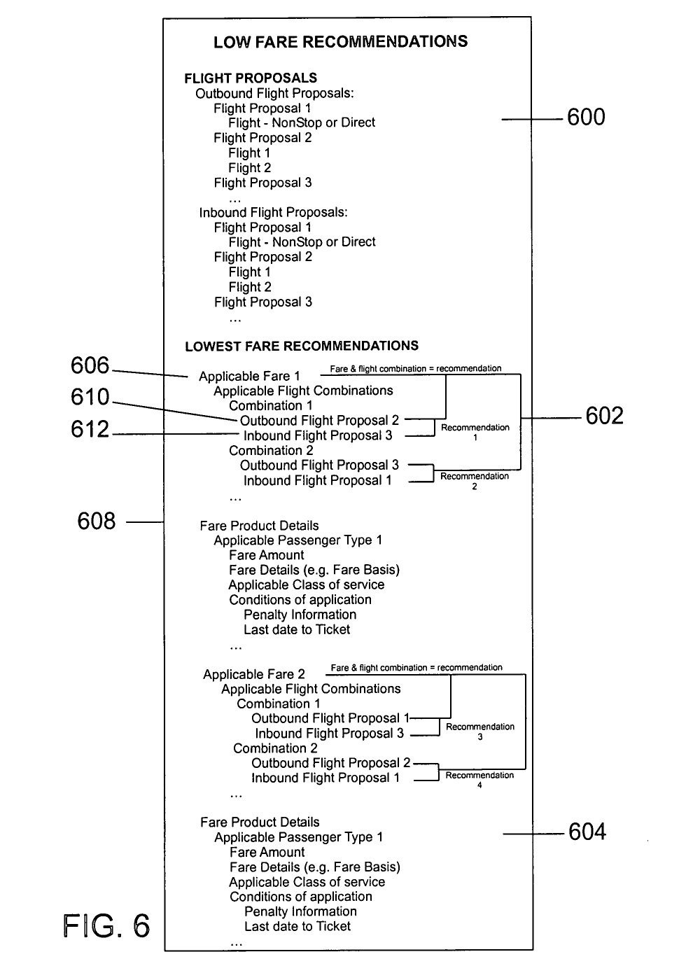

In order to carry out the search request as is required for online searching of a product or service, in this case a flight inquiry, requires a number of elements. An input module is required to allow the user to enter the search request and interface with the booking engine, which in turn will interface with the GDS system. The input module may include means for storing both the search that is made and any results resulting therefrom. A search engine is required to carry out the searching and to determine recommendations that match the search that is made by the user. A communications module is required in order to display the search information to the user so that further selection and or purchase can be carried out. In accordance with an embodiment of the present invention there is a requirement to change a certain criteria related to the search, for example a range of dates is rather than a specific date or whatever. The system will require a module to perform this change, whether it is user or system instigated. Once the results have been received and if appropriate stored, it is then necessary to bring the results together in a predetermined manner to provide a predetermined result profile of the first and second set of recommendations to the user. This can be carried out in the user equipment or elsewhere. The various interactions between the browser, the booking engine and the GDS for a simple request is shown with respect to FIG. 4. The vertical lines correspond respectively to the browser 400, the booking engine 402, the API 404 and the GDS 406. The horizontal lines or arrows represent information transferring from one part of the system to another, i.e. for example from the browser to the booking engine. The online user enters a set of such data 408 into an appropriate means on the browser. The search data is sent to the booking engine 410. At the booking engine the search data is converted to in API format 412 and a request is transferred to the API 414. The API then sends an API request to the GDS 414 (this will be described in more detail with respect to FIG. 5). The GDS generates an API reply 418 to the API (this will be described in more detail with respect to FIG. 6). The API then send a reply back to the booking engine 420 and the booking engine constructs a set of recommendations from a mix of flight and fare information 422. The booking engine may then apply business rules 424 and post processing such as filtering or sorting 426 as is required. The booking engine then sends recommendations 428 that meet the original search data back to the browser to be viewed by the online user.

An example of an API request structure is shown in FIG. 5. The structure is in the form of a general query which includes a number of essential parameters. These include:
number of passengers
a number of desired recommendations
starting location
destination location
date for start
date for return
other optional parameters.
   The layout and position of each element of this data will be as required by the particular GDS and booking engine combination. Some or all of the data may be entered by the online user and some of the data may be automatically generated.

An example of a typical API reply structure is shown in FIG. 6. The reply features a section called “flight proposals” and a section named “lowest fare recommendations”. In order to minimize the amount of data that is sent on a communication channel the “lowest fare recommendations” section references flights contained in the “flight proposals” section. It should be noted that each flight can be referenced several times. The API reply structure includes flight proposals 600 for outbound flights, inbound flights or both depending on the search request. In addition a set of lowest fare recommendations 602, 604 etc is also included. Referring to the lowest fare recommendations this includes for example the information shown relating to applicable fare number one 606 and fare product details 608. Applicable fare number one includes applicable flight combinations, in the examples shown there are two, combination one and combination two. Each combination includes an outbound flight proposal and an inbound flight proposal, for example 610 and 612. The applicable fare one and the outbound flight proposal 610 in the inbound flight proposals 612 constitute recommendation one in the example shown. The API reply also includes recommendations two, recommendation three and recommendation four. It will be appreciated that there could be any number of recommendations depending on the parameters of the API reply, memory capacity or many other factors.

When the API reply is received at the booking engine a recommendation construction process is carried out. This involves constructing objects that associate fare details contained in the fare product details section with the flight combinations they referred to. This process is well known in the art and it is not necessary to describe this part of the process for the present invention.

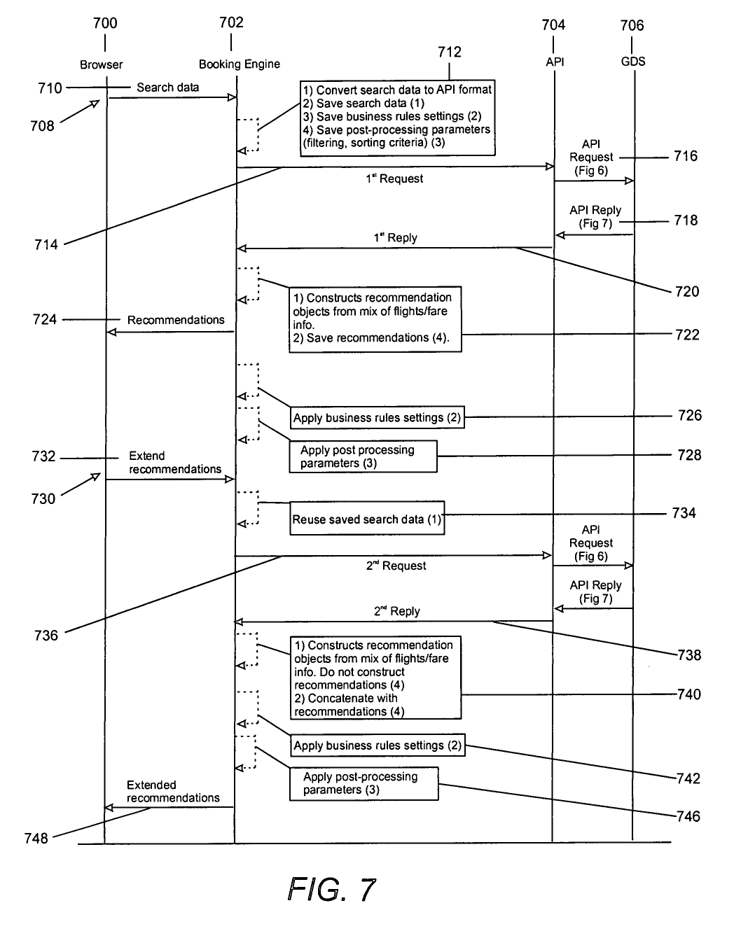

FIG. 7 illustrates the interactions between the browser, booking engine, API and GDS when a simple request is extended in accordance with the present invention. Again the vertical lines of and 700, 702, 704 and 706 relate respectively to the browser, booking engine, API and GDS. The online user enters search criteria 708 which are communicated from the browser to the booking engine 710. The search data is converted to an API format and the data is saved along with business rules settings and post processing parameters 712. These may include addition fees, such as agents service fees etc . . . The first request 714 is sent to the API and then generates an API request as is shown in FIG. 5 716. The API reply as shown in FIG. 6 is then returned to the API 718 and the first reply 720 is sent back to the booking engine. The booking engine and then constructs recommendation objects from the mixture of flights and fare information and saves the recommendations in a cache 722. These recommendations are then communicated to the browser for viewing by the user through message 724. If required business rules settings 726 and post processing parameters 728 may be applied to the recommendations.

At a certain point in time the user may determine that they wishes to change the recommendations currently received. The user activates this at 730 with a request to change recommendations 732. The booking engine then reuses the saved search data 734 to generate a second request 736 which is sent to the API. The data from the first request is enriched with a data range that may be generated by the user or may be an integral part of the system. Alternatively, another filter may be applied to change one of the search criteria detailed to make it either broader or narrower. The API request and reply is then generated as previously described between the API and the GDS, and the API generates a second reply 738. The booking engine then constructs recommendation of the objects from the mix of flights and fare and then concatenates the two sets of recommendations: those from the first reply and those from the second reply (740).

To ensure maximum result accuracy it is desirable to eliminate any duplicates that occur in both sets of recommendations. This is to ensure that un-necessary computing and memory resource wastage is minimized. The recommendations resulting from the first request stored at the booking engine and the results from the second request then received by the booking engine such that the booking engine will include only recommendations from the second set of recommendations that were not as a result of the first request, in the concatenated recommendations. Comparing all the attributes for the result of the first request with the attributes of the results of the second request can be very costly both computationally and in terms of time. This invention features an optimized duplication elimination engine that significantly reduces this cost and the time of processing.

Referring to the API reply structure shown in FIG. 6, two recommendations are considered to be duplicates if:
outbound and inbound flight proposals, amount and tax amount (part of the fare product details) are equal;
two flight proposals are considered equal if their flights are equal; and/or
two flights are equal if dates, times, flight numbers, carriers and fare bases are equal.
   The duplicate elimination engine is initialized with the recommendations that result from the first request. The above-mentioned equality criteria are then applied to the results from the second request by selecting the most unique elements of the data for comparison. For example, the most cost effective criteria are applied first to minimize the amount of calculation required. For example comparing fare amounts is considerably more cost-effective than comparing flight proposals as the computational burden is significantly less. In other situations the most cost effective criteria may be different. The manner in which this cost effective criteria is selected will depend on the circumstance of the environment in which the invention is operating.

Once again business rules settings 742 and post processing parameters 746 may be applied to the concatenated recommendations before an extended set of recommendations is returned to the user and displayed on the browser 748.

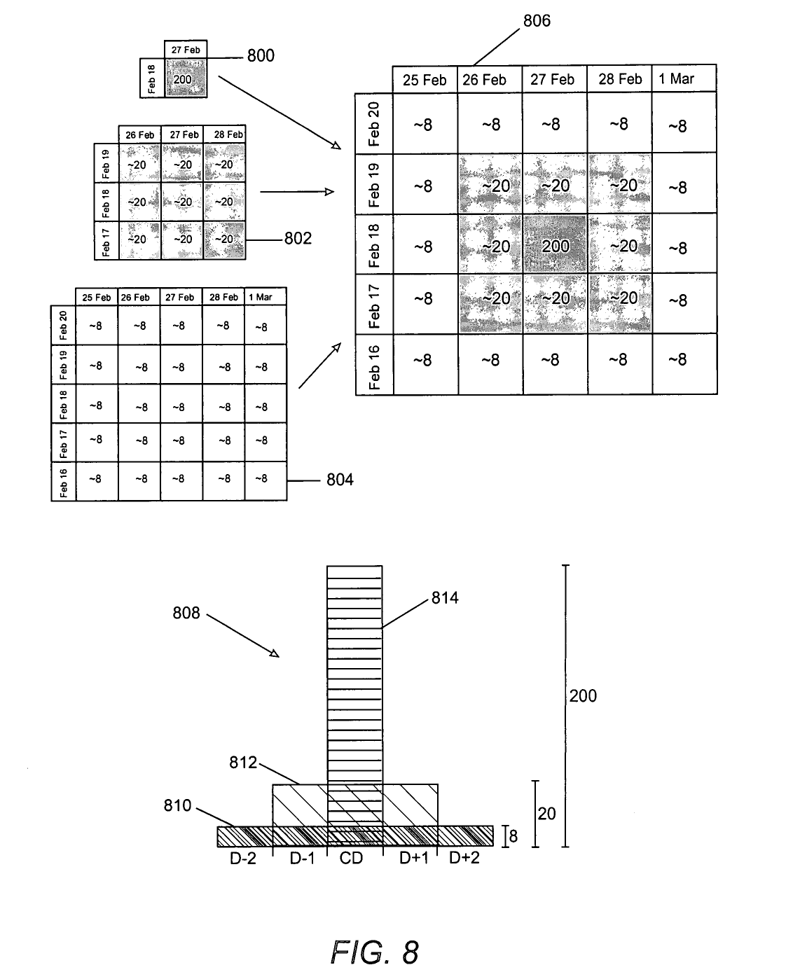

It should be noted that as previously indicated the date flexibility can vary in the case of different matrices. An example is shown in FIG. 8 of a search result of a certain profile. In addition the following table sets out the number of recommendations on the central date and the surrounding dates. The central date is the original date entered by the online user at the first instance and the surrounding dates are those within the range of days either side of the central date for both the outbound and return journeys.

| | | Number of | Recommendations |
|---|---|---|---|
| | Recommendations | surrounding | on each |
| Matrix size | on central date | days | surrounding date |
| 3 × 3 | 200 | 8 | ~25 |
| 5 × 5 | 200 | 24 | ~8 |
| 7 × 7 | 200 | 48 | ~4 |

The results of the search, whether by a concurrent request or a sequential request is a selection of individual searches that are consolidated in accordance with an embodiment of the present invention. For each search there is a maximum number of recommendations for example 200. For the “deep” element of the search all the results are in respect of the particular date combination that was entered by the user. In other words there are 200 recommendations in respect of the date combination selected by the user as shown at 800. An increase of the date range of plus or minus one gives rise to a result profile as shown at 802. For each of the nine dates there are approximately 20 to 25 recommendations, adding up to approximately 200 recommendations in total. An increase of the date range to plus or minus two gives rise to a result profile as shown that 804. Here there are 25 possible date combinations and each includes a recommendation total that is equal to the maximum number of recommendations divided by the number of possible date (in this case 200 divided by 25). This results in approximately 8 recommendations for each date combination. The resolution of the search decreases from the centre to the edges of the consolidated result profile shown at 806. The number of recommendations and the shape of the result profile can be varied in accordance with the requirements of the application in question. The result profile does not need to be based on a square matrix that could be based on another form, where the extension in one direction is different from the extension in the other.

The cross sectional profile shown at 808 portrays the result profile in a slightly different manner. The results have a profile in which the total number of recommendations in each of the three blocks 810, 812 and 814 each include approximately 200 recommendations, it should be noted that the blocks are two-dimensional although this is not shown. The indicated CD stands for central date and D−2, D−1, D+1 and D+2 are plus or minus days from the central date.

Irrespective of the nature of the matrix and/or the required result profile the individual results may be brought together by means of either a concurrent request or a sequential request, as previously described. In the case of a concurrent request all three sets of search results 800, 802 and 804 will be collected at the same time and stored in a cache until required. For the sequential request, the results for the specific date combination 800 received first and then the others may be requested either together or separately by any appropriate process.

It will be appreciated that the method of the above describes expending a specific combination of dates, although it will be appreciated that this can work in reverse. In other words a range of dates is entered and the specific dates are later selected either through a concurrent requests and or a sequential request.

The results of the two requests must be merged in order that they can be viewed together. In order to manage the results the booking engine will store the results of the first request in a cache. The process of sending the second requests to backend is totally transparent to the online user. This is due to the fact that the search scope entered in the first request is persistent and is unchanging for any other requests in that session. This is an important element of the invention.

In addition to the ability to manage the results of two specific requests that have been derived from the same input data, the reservation system according to the present invention will also allow changes to the request in respect of other functions. For example the request may be tuned to include only certain preferred airlines, times of departures or any other kind of filter. The invention ensures that all the additional search parameters entered at the first instance continue between the first and second request to ensure the transparency and operation of the invention as described.

This invention has been described with reference to the flight (or any other travel, entertainment, ticketing) environment, however it will be appreciated that this invention could be applied to any other type of online booking service or product purchase environment. The manner in which the duplication elimination engine operates is an important part of the present invention that could be implemented in a different manner than that described above.

It will be appreciated that the main part of the invention has been described predominantly with respect to extending the first search criteria entered by the user. However, as previously indicated it would be possible to change the range of the search criteria from a broader to a more narrow range. This would be in compliance with the case where a flexible date range is entered as the first search criteria and then narrowed down to a specific date for the second search criteria.

It will be further appreciated that the examples shown are just that and many other examples for various features could be anticipated which fall within the scope and spirit of the present invention.

1. A method of online searching for a service or product, the method comprising:
obtaining a search request from a user, the search request including a set of search criteria;
storing the set of search criteria at a predetermined location;
searching for a service or product which matches the set of search criteria;
generating a first set of recommendations of a service or product which matches the set of search criteria for communication to the user;
storing the first set of recommendations;
generating a second request to change the range of at least one of the set of search criteria of the first search request in a predetermined manner;
retrieving the set of search criteria from the predetermined location to form the basis of the search criteria for the second request;
changing at least one of the search criteria of the set of search criteria in said predetermined manner to form a changed set of search criteria;
searching for a service or product which matches the changed set of search criteria;
generating a second set of recommendations of the service or product which matches the changed search criteria for communication to the user;
concatenating the first set of recommendations with the second set of recommendations to form a concatenated set of recommendations having a predetermined result profile.

2. The method of claim 1, wherein the step of retrieving comprises retrieving a predetermined number of recommendations.

3. The method of claim 1, wherein concatenation occurs so as to ensure that no duplicates occur in the concatenated set of recommendations.

4. The method of claim 1, further comprising changing the at least one of the search criteria of the set of search criteria to be a range of values.

5. The method of claim 1, further comprising changing the at least one of the search criteria of the set of search criteria to be a more specific value.

6. The method of claim 1, further comprising receiving the search request from the user by means of a browser.

7. The method of claim 6, further comprising communicating the request from the browser to a booking engine.

8. The method claim 1, wherein the steps of searching for a service or product comprises sending a request for recommendations matching the set of search criteria from a booking engine to a global distribution system (GDS) using an API interface.

9. The method of claim 1, further comprising storing the set of search criteria and the first set of recommendations in a cache at a booking engine.

10. The method of claim 1, wherein the step of concatenating the first and second set of recommendations comprises:
selecting one of the set of search criteria as a means for comparing the first and second set of recommendations; and
adding the second set of recommendations to the first set of recommendations except when the selected search criteria is the same for the second set of recommendations as for the first set of recommendations.

11. The method of claim 10, wherein the step of selecting comprises using the search criteria which requires the minimum amount of processing in a comparison step.

12. The method of claim 1, further comprising using the method for searching for a travel reservation.

13. A system for online searching for a product or service, the system comprising:
an input module for obtaining a search request from the user, the search request including a set of search criteria, wherein the search was criteria are stored at a predetermined location;
a search engine for searching for a product or service that matches the set of search criteria and producing a first set of recommendations of the service or product which matches the set of search criteria;
a communications module which communicates and stores the first set of recommendations;
a generator for generating a change in the range of one or more of the set of search criteria to perform a changed set of search criteria;
wherein the search engine produces a second set of recommendations of a service or product which matches the changed set of search criteria and wherein the system further includes a generator generating a predetermined result profile of the first and second set of recommendations.

14. A computer program comprising instructions for carrying out the steps of the method according to claim 1, when said computer program is executed on a computer system.
